(19) United States
(12) Patent Application Publication
(10) Pub. No.: US 2014/0292902 A1
(43) Pub. Date: Oct. 2, 2014

(54) WHITE-BASED PIGMENT, WHITE-BASED INK COMPOSITION, INK SET, AND INK JET RECORDING METHOD

(71) Applicant: Seiko Epson Corporation, Tokyo (JP)

(72) Inventors: Takayoshi Kagata, Shiojiri-shi (JP); Shoki Kasahara, Shiojiri-shi (JP)

(73) Assignee: SEIKO EPSON CORPORATION, Tokyo (JP)

(21) Appl. No.: 14/227,783

(22) Filed: Mar. 27, 2014

(30) Foreign Application Priority Data
Mar. 27, 2013 (JP) 2013-066490

(51) Int. Cl. C09D 11/00

(52) U.S. Cl. CPC C09D 11/322
USPC 347/20; 524/104; 428/402; 347/100

(57) ABSTRACT

A white-based pigment has an S of at least 0.15. The S is defined by equation (1):

$$S = \frac{K 1 \times ( 1 - K 2 ) \times {a ( K 3 )}^{2}}{K 4} \qquad ( 1 )$$

where K1, K2, K3, and K4 are a structural factor, a porosity, a particle diameter, and a specific gravity, respectively, and 0<K1, 0<K2<1, 1.5×10⁻⁷ (m)≦K3≦1.0×10⁻⁵ (m), 2≦K4≦8, and a=1.0×10¹³ (m⁻²).

Priority is claimed under 35 U.S.C. §119 to Japanese Application No. 2013-066490 filed on Mar. 27, 2013, is hereby incorporated by reference in its entirety.

### BACKGROUND

1. Technical Field

The present invention relates to a white-based pigment, a white-based ink composition, an ink set, and an ink jet recording method.

2. Related Art

White-based ink compositions that contain a white-based pigment have been used in various printing methods. Examples of white-based pigments used include metal oxides such as titanium dioxide, zinc oxide, silica, alumina, and magnesium oxide, barium sulfate, and calcium carbonate. Such white-based ink compositions have several uses; for example, color images on recording media such as plastic or metal products, whose base color is not always white, can be made brighter by erasing the base color with a white-based ink composition. Likewise, a color image on a transparent sheet can be made less transparent by forming a coating of a white-based ink composition to provide a white masking layer.

It is therefore desirable that a white-based ink composition satisfy various performance requirements including the following for use in the aforementioned applications: (1) high whiteness, (2) high abrasion resistance, i.e., high physical strength of pigment particles, and (3) good masking properties of the recorded white images and (4) excellent dispersion of the white-based pigment.

Several studies on the composition of white-based ink and on white-based pigments from such perspectives have been reported. For example, JP-A-2007-211176 discloses an ink composition that contains a white-based pigment, a polymerizable compound, and a polymerization initiator. The white-based pigment in this ink composition is composed of inorganic or inorganic-organic hybrid hollow particles. JP-A-2007-211036 discloses an ink composition that contains several groups of hollow polymer fine particles. These groups of particles have similar average particle diameters, with the difference between each group and the next less than 100 nm. Japanese Patent No. 4579823 discloses a core-shell particle that has a core portion and a shell portion. This particle has a total reflectivity of at least 70% at the boundary between the core portion and the shell portion, and the shell portion is composed of at least one plastic layer, or more specifically at least one layer of a low-refractive-index material that contains fine particles of a high-refractive-index material.

However, simply changing the composition of white-based ink as in JP-A-2007-211176 is insufficient to make the ink satisfy the above requirements. Likewise, it is difficult to obtain a white-based ink composition that satisfies the above requirements by simply controlling the quality of the material of the white-based pigment or the particle diameter of the white-based pigment as in JP-A-2007-211036 or Japanese Patent No. 4579823; these approaches are insufficient especially to solve the problem of poor dispersion of the white-based pigment in the white-based ink composition.

### SUMMARY

An advantage of some aspects of the invention is that these aspects of the invention provide the following: a white-based pigment that quickly disperses in ink compositions and provides white images that have excellent whiteness, physical strength of pigment particles, and masking properties; a white-based ink composition that contains such a white-based pigment; an ink set that includes such a white-based ink composition; and an ink jet recording method that includes using such an ink set.

The following describes some aspects or illustrative applications of the invention.

### Application 1

A form of a white-based pigment according to an aspect of the invention has an S of at least 0.15. The S is defined by equation (1):

$$S = \frac{K 1 \times ( 1 - K 2 ) \times {a ( K 3 )}^{2}}{K 4} \qquad ( 1 )$$

where K1, K2, K3, and K4 are a structural factor, a porosity, a particle diameter, and a specific gravity, respectively, and 0<K1, 0<K2<1, 1.5×10⁻⁷ (m)≦K3≦1.0×10⁻⁵ (m), 2≦K4≦8, and a=1.0×10¹³ (m⁻²).

The white-based pigment of Application 1 quickly disperses in ink compositions and provides white images that have excellent whiteness, physical strength of pigment particles, and masking properties.

### Application 2

A form of a white-based ink composition according to another aspect of the invention contains the white-based pigment of Application 1.

### Application 3

The white-based ink composition of Application 2 can be a textile printing ink.

### Application 4

A form of an ink set according to another aspect of the invention includes the white-based ink composition of Application 2 and a clear ink composition. The clear ink composition is substantially free of coloring materials.

### Application 5

The ink set of Application 4 can be configured so that the white-based ink composition contains a binder resin that has a refractive index of less than 1.6.

### Application 6

A form of an ink set according to another aspect of the invention includes the white-based ink composition of Application 2 and a color ink composition that contains a coloring material. The coloring material in the color ink composition has a particle diameter longer than the largest surface void diameter of the white-based pigment in the white-based ink composition.

### Application 7

A form of an ink jet recording method according to another aspect of the invention include using the ink set of any of Applications 4 to 6.

### Application 8

A form of an ink jet recording method according to another aspect of the invention includes using the ink set of Application 6 with a recording head. The recording head operates on a greater potential difference to discharge the white-based ink composition than to discharge the color ink composition.

### BRIEF DESCRIPTION OF THE DRAWINGS

The invention will be described with reference to the accompanying drawings, wherein like numbers reference like elements.

FIG. 1 is a cross-sectional diagram that schematically illustrates the structure of a particle in a white-based pigment that satisfies the relation 0<K1.

FIG. 2 is another cross-sectional diagram that schematically illustrates the structure of a particle in a white-based pigment that satisfies the relation 0<K1.

FIG. 3 is a different cross-sectional diagram that schematically illustrates the structure of a particle in a white-based pigment that satisfies the relation 0<K1.

FIG. 4 is a schematic diagram that illustrates a typical drive pulse in a signal that drives a recording head.

FIG. 5 is a schematic diagram that illustrates a typical waveform of a drive pulse in a signal that drives a recording head.

### DESCRIPTION OF EXEMPLARY EMBODIMENTS

The following describes some preferred embodiments of the invention. These embodiments are for illustration purposes only and should not be construed as limiting the scope of the invention. The invention includes all modifications that can be implemented without departing from the gist thereof.

### 1. WHITE-BASED PIGMENT

A white-based pigment according to this embodiment has an S of at least 0.15. The S is defined by equation (1):

$$S = \frac{K 1 \times ( 1 - K 2 ) \times {a ( K 3 )}^{2}}{K 4} \qquad ( 1 )$$

where K1, K2, K3, and K4 are a structural factor, a porosity, a particle diameter, and a specific gravity, respectively, and 0<K1, 0<K2<1, 1.5×10⁻⁷ (m)≦K3≦1.0×10⁻⁵ (m), 2≦K4≦8, and a=1.0×10¹³ (m⁻²).

The parameter K1 in equation (1) represents a structural factor and is a dimensionless number. The structural factor as mentioned herein is a factor derived from the ratio of the actual specific surface area of the particles in the white-based pigment (hereinafter referred to as white-based-pigment particles) to the surface area of these particles calculated on the assumption that each particle were a perfect sphere. The structural factor K1 therefore indicates how active the structure of the white-based-pigment particles is compared to imaginary perfect spheres. The structural factor K1 is given by equation (2).

K1=log₁₀(T2/T1) (2)

The parameter T1 in equation (2) is the surface area of the white-based-pigment particles calculated on the assumption that each particle were a perfect sphere; therefore, T1=4πr², where r is the radius of the white-based-pigment particles. The radius r can be determined from the volume-average particle diameter of the white-based-pigment particles obtained by the following method: the particles are analyzed using a laser diffraction particle size distribution analyzer to detect a pattern of distribution of the intensity of diffracted/scattered light, the obtained light intensity distribution pattern is used to calculate the volume-based particle size distribution in accordance with Mie scattering theory, and then the volume-average particle diameter is calculated from the obtained particle size distribution. The volume-average particle diameter determined by such a method corresponds to the particle diameter the white-based-pigment particles would have if each were a perfect sphere. Examples of laser diffraction particle size distribution analyzers that can be used in such a method include Microtrac UPA (Nikkiso Co., Ltd.).

The parameter T2 in equation (2) is the specific surface area of the white-based-pigment particles determined by gas adsorption. Gas adsorption is an analytical method in which particles are allowed to adsorb molecules of a gas with a known coverage (i.e., the area occupied by the adsorbed molecules) onto the surface and the void thereof, and the amount of the adsorbed gas is used to determine the specific surface area of the particles. Examples of instruments that can be used to measure the specific surface area of particles by gas adsorption include FlowSorb III 2305/2310 automated dynamic-flow specific surface area analyzers, Gemini 2360/2375 automated specific surface area analyzers, and ASAP 2020 accelerated specific surface area and porosimetry system (Shimadzu Corporation).

The white-based-pigment particles are regarded as being active to at least some extent if the structural factor K1 is more than zero (0<K1). Preferably 0.5≦K1≦10, and more preferably 1≦K1≦5, in particular 2≦K1≦4. In general, the percentage of the void in the white-based-pigment particles increases and the physical strength of the white-based-pigment particles decreases with increasing K1.

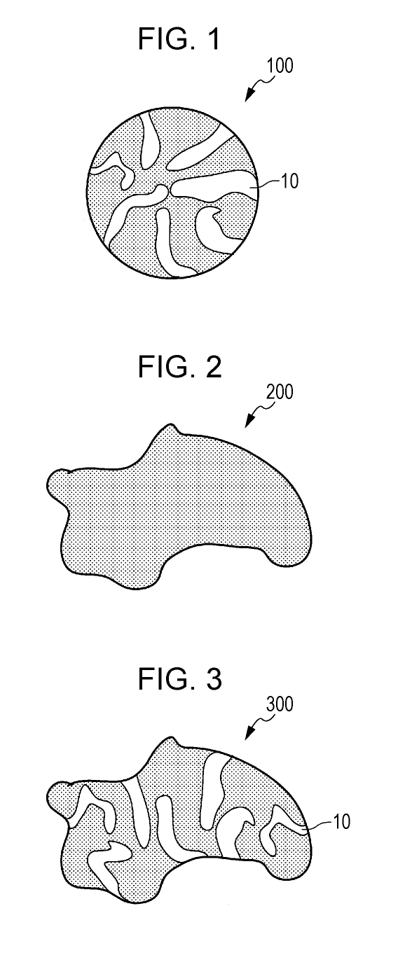

Some examples of white-based-pigment particles that have a structural factor K1 of more than zero are provided. The white-based-pigment particle 100 in FIG. 1 has a void portion 10 that extends inward from the surface of the roughly spherical particle. The white-based-pigment particle 200 in FIG. 2 has an irregular shape. The white-based-pigment particle 300 in FIG. 3 has a void portion 10 that extends inward from the surface of the irregular-shaped particle.

The parameter K2 in equation (1) represents a porosity and is a dimensionless number. The porosity as mentioned herein is the fraction of void of the white-based-pigment particles provided by mercury intrusion and can be calculated from the bulk volume of the particles and from the capacity of pores determined by mercury intrusion. In the mercury intrusion technique the capacity of pores of the particles of interest is first determined from the pressure used to force mercury into the pores and the amount of mercury that intrudes, and this capacity of pores and the initial volume of the particles (bulk volume) are used to calculate the porosity. Examples of instruments that can be used to measure the capacity of pores of particles by mercury intrusion include AutoPore IV 9520 pore size distribution analyzer (Shimadzu Corporation).

The porosity K2 is more than zero to less than one (0<K2<1). Preferably 0.1≦K2≦0.9, and more preferably 0.2≦K2≦0.8, in particular 0.3≦K2≦0.7. When the porosity K2 of the white-based-pigment particles is in these ranges, the white-based-pigment particles quickly disperse in ink compositions because the dispersion medium can intrude into the void of the particles. Although the physical strength of the white-based-pigment particles decreases with increasing porosity, the particles maintain good physical strength and the resulting white images will have good resistance to abrasion as long as K2 falls within these ranges.

The parameter K3 in equation (1) represents a particle diameter in meters. The particle diameter as mentioned herein is a volume-average particle diameter obtained by the following method: the particles are analyzed using a laser diffraction particle size distribution analyzer to detect a pattern of distribution of the intensity of diffracted/scattered light, the obtained light intensity distribution pattern is used to calculate the volume-based particle size distribution in accordance with Mie scattering theory, and then the volume-average particle diameter is calculated from the obtained particle size distribution. Examples of laser diffraction particle size distribution analyzers that can be used in such a method include Microtrac UPA (Nikkiso Co., Ltd.).

The particle diameter K3(m) is in the range of 1.5×10⁻⁷ to 1.0×10⁻⁵, both inclusive (1.5×10⁻⁷≦K3≦1.0×10⁻⁵). Preferably 2.0×10⁻⁷≦K3≦1.0×10⁻⁶, and more preferably 3.0×10⁻⁷≦K3≦6.0×10⁻⁷. The white-based-pigment particles quickly disperse in ink compositions and the resulting white images will have excellent whiteness and masking properties when the particle diameter K3 is in these ranges.

The parameter K4 in equation (1) represents a specific gravity and is a dimensionless number. The specific gravity as mentioned herein is not the specific gravity of the white-based-pigment particles, but that of the constituents of the white-based-pigment particles. The specific gravity K4 therefore does not vary depending on the shape or other structural attributes of the white-based-pigment particles and is unique to the composition of the particles. The specific gravity K4 is in the range of 2 to 8, both inclusive (2≦K4≦8).

The factor S given by equation (1) is technically significant for the following reason. The numerator K1×(1−K2)×a(K3)² in equation (1) is a parameter that indicates how active white-based-pigment particles that have a particle diameter K3 are in the solid portion thereof, i.e., expect in the void portion. This activity parameter determines whether the resulting white images will have excellent whiteness, physical strength of pigment particles, and masking properties. More specifically, the term (1−K2) represents the fraction of the solid portion of the white-based-pigment particles and is directly linked to the physical strength of the particles. The term (K3)² represents a power of the particle diameter of the white-based-pigment particles and is directly linked to the whiteness and masking properties of the resulting images. The remaining term K1 denotes the degree of activation of the white-based-pigment particles. Multiplying these terms gives a value that indicates how active the white-based-pigment particles with a particle diameter K3 are in the solid portion thereof. The inventors' research has revealed that activating the pigment particles in a white-based pigment enhances the whiteness and masking properties of the resulting images.

Dividing the numerator K1×(1−K2)×a(K3)² by the specific gravity K4 in equation (1) adds the contribution of dispersibility. More specifically, the white-based-pigment particles become more likely to settle, i.e., less dispersible, in ink compositions with increasing specific gravity K4.

Examples of materials for the white-based pigment according to this embodiment include, but are not limited to, metal oxides such as titanium dioxide, zinc oxide, silica, alumina, and magnesium oxide, barium sulfate, calcium carbonate, and hollow plastic particles. Examples of hollow plastic particles that can be used include those described in U.S. Pat. No. 4,880,465 and other patent publications. Titanium dioxide is preferred to other materials for white-based pigments in terms of the whiteness and the masking properties of the resulting images and the physical strength of pigment particles.

### 2. WHITE-BASED INK COMPOSITION

A white-based ink composition according to this embodiment contains the white-based pigment described above. The white-based pigment quickly disperses in the ink composition and allows the white-based ink composition to provide white images that have excellent whiteness, physical strength of pigment particles, and masking properties.

The white-based pigment content (on a solid basis) is preferably in the range of 1% to 20% by mass, both inclusive, more preferably 5% to 15% by mass, both inclusive, based on the total mass of the white-based ink composition. This makes it more likely that the white-based pigment can quickly disperse in the white-based ink composition and the resulting white images can have excellent whiteness, physical strength, and masking properties.

The “white-based inks” are inks (inkt) with which colors that are called “white” according to the social conventions can be recorded and include slightly colored ones. Further, the white-based inks containing pigments include inks (inkt) called or commercially available under trade names such as “white colored ink (inkt), white ink (inkt)”. The white-based ink further include, for example, inks (inkt) that satisfy: the lightness (L*) and the chromaticity parameters (a* and b*) of the ink fall within the ranges of 70 to 100, −4.5 to 2, and −6 to 2.5 (70≦L*≦100, −4.5≦a*≦2, and −6≦b*≦2.5) when the ink (inkt) applied to a sheet of Epson photographic glossy paper (Seiko Epson Corp.) at a duty of at least 100% or in an amount that coats the entire surface of the sheet is analyzed using Spectrolino spectrophotometer (a trade name, GretagMacbeth) under the following conditions: light source, D50; field of view, 2°; density, DIN NB; white balance, Abs; filter, No; mode of measurement, Reflectance.

The “duty” in the above definition of white-based inks is calculated by the following equation:

Duty (%)=Actual number of dots discharged/(Vertical resolution×Horizontal resolution)×100,

where the “actual number of dots discharged”, the “vertical resolution”, and the “horizontal resolution” are all values per unit area.

The white ink composition according to this embodiment may contain other appropriate components such as a binder resin, water, an organic solvent, and a surfactant.

Preferably, the white ink composition according to this embodiment contains a binder resin. Binder resins improve the resistance to abrasion and other measures of physical strength of the pigment particles in the resulting white images. Specific examples of binder resins that can be used include polyester resins, fluorene resins, and styrene-acrylic resins.

Polyester resins improve the fixation of the resulting white images and can also improve the abrasion resistance of the images. Examples of polyester resins that can be used include polymers synthesized from a polyol and a polybasic carboxylic acid by known processes.

Examples of polyols that can be used include ethylene glycol, diethylene glycol, 1,3-propanediol, 1,4-butanediol, 1,4-cyclohexanedimethanol, trimethylol propane, and pentaerythritol. It is also possible to use two or more such polyols in combination.

Examples of polybasic carboxylic acids that can be used include oxalic acid, succinic acid, tartaric acid, malic acid, citric acid, phthalic acid, isophthalic acid, terephthalic acid, 2,6-naphthalenedicarboxylic acid, and adipic acid. It is also possible to use two or more such polybasic carboxylic acids in combination.

Commercially available polyester resins can also be used, including Eastek 1100 and 1300 (trade names, Eastman Chemical Japan) and elitel KT-8830, KT-1449, and KT-8701 (trade names, UNITIKA Ltd.).

The amount of such a polyester resin (on a solid basis) is preferably in the range of 1% to 5% by mass, both inclusive, more preferably 2% to 4% by mass, both inclusive, in particular 3% to 4% by mass, both inclusive, based on the total mass of the white-based ink composition so that the effect of the polyester resin on the fixation of the resulting white images can be more noticeable.

Adding a fluorene resin and/or a styrene-acrylic resin to the white-based ink composition enhances the physical strength of the pigment particles in the resulting white images. This means that the resistance to abrasion of the white images is enhanced and the fixation of the images can also be improved.

Examples of fluorene resins that can be used include all polymers that contain the fluorene skeleton such as those obtained by the reaction of a polyisocyanate and a polyol component that includes a first diol that has the fluorene skeleton and a second diol that has a hydrophilic group.

The weight-average molecular weight of such a fluorene resin is preferably in the range of 2000 to 20000, both inclusive, more preferably 3000 to 20000, both inclusive, so that the fluorene resin will not make the white-based ink composition too viscous.

Examples of styrene-acrylic resins that can be used include styrene-acrylic acid copolymers, styrene-methacrylic acid copolymers, styrene-methacrylic acid-acrylate copolymers, styrene-α-methyl styrene-acrylic acid copolymers, and styrene-α-methyl styrene-acrylic acid-acrylate copolymers. All of the random, block, alternating, and graft forms of copolymers can be used.

Commercially available styrene-acrylic resins can also be used. Specific examples of commercially available styrene-acrylic resins include JONCRYL 62J (BASF Japan Ltd.).

The weight-average molecular weight of such a styrene-acrylic resin is preferably in the range of 1000 to 10000, both inclusive, more preferably 1800 to 8000, both inclusive, so that the styrene-acrylic resin will not make the white-based ink composition too viscous.

The total amount of such a fluorene resin and a styrene acrylic resin (on a solid basis) is preferably in the range of 0.2% to 5% by mass, both inclusive, more preferably 0.4% to 3% by mass, both inclusive, in particular 0.5% to 2% by mass, both inclusive, based on the total mass of the white-based ink composition so that the effect of the fluorene resin and/or the styrene acrylic resin on the fixation of the resulting white images can be more noticeable.

The white-based ink composition according to this embodiment is preferably an “aqueous” ink composition, or more specifically an ink composition that contains at least 50% water by mass, so that the recorded images can dry faster and the ink itself can be more environmentally friendly.

The white ink composition according to this embodiment may contain an organic solvent. Examples of organic solvents that can be used include the following: 1,2-alkanediols such as 1,2-propanediol, 1,2-butanediol, 1,2-pentanediol, 1,2-hexanediol, and 1,2-octanediol; polyhydric alcohols such as ethylene glycol, diethylene glycol, propylene glycol, dipropylene glycol, 1,3-propanediol, 1,4-butanediol, 1,6-hexanediol, trimethylol propane, and glycerol; and pyrrolidones such as N-methyl-2-pyrrolidone, N-ethyl-2-pyrrolidone, N-vinyl-2-pyrrolidone, 2-pyrrolidone, N-butyl-2-pyrrolidone, and 5-methyl-2-pyrrolidone.

The white ink composition according to this embodiment may contain a surfactant. Examples of surfactants that can be used include silicone surfactants and acetylene glycol surfactants.

Examples of preferred silicone surfactants include polysiloxanes, such as polyether-modified organosiloxanes. Specific examples include BYK-306, BYK-307, BYK-333, BYK-341, BYK-345, BYK-346, and BYK-348 (trade names, BYK Japan KK) and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, Shin-Etsu Chemical Co., Ltd.). Silicone surfactants are effective in spreading the white-based ink composition uniformly on a recording medium without causing density irregularities or bleeding. When a silicone surfactant is used, the silicone surfactant content is preferably in the range of 0.1% to 1.5% by mass, both inclusive, based on the total mass of the white-based ink composition.

Examples of acetylene glycol surfactants that can be used include SURFYNOL 104, 104E, 104H, 104A, 104BC, 104DPM, 104PA, 104PG-50, 104S, 420, 440, 465, 485, SE, SE-F, 504, 61, DF37, DF110D, CT111, CT121, CT131, CT136, TG, and GA (trade names, Air Products and Chemicals, Inc.), OLFINE B, Y, P, A, STG, SPC, E1004, E1010, PD-001, PD-002W, PD-003, PD-004, EXP.4001, EXP.4036, EXP.4051, AF-103, AF-104, AK-02, SK-14, and AE-3 (trade names, Nisshin Chemical Industry Co., Ltd.), and ACETYLENOL E00, E00P, E40, and E100 (trade names, Kawaken Fine Chemicals Co., Ltd.). Acetylene glycol surfactants help to maintain moderate levels of surface tension and interfacial tension more effectively than other surfactants and are unlikely to foam. When an acetylene surfactant is used, the acetylene surfactant content is preferably in a range of 0.1% to 1.5% by mass, both inclusive, based on the total mass of the white-based ink composition.

The white-based ink composition according to this embodiment may further contain additives such as pH-adjusting agents, preservatives/antimolds, antirusts, and chelating agents.

The white-based ink composition according to this embodiment may be used as a textile printing ink, i.e., an ink for making recordings on ink-absorbent recording media such as fabrics, because the white-based ink composition provides white images that have excellent whiteness, physical strength of pigment particles, and masking properties and the white-based pigment probably quickly penetrates into the fiber. Recording white images on fabrics by using the white-based ink composition according to this embodiment as a textile printing ink can provide higher abrasion resistance to the images.

Preferably, the white ink composition according to this embodiment is not a radiation-curable ink that contains 30% or more polymerizable monomer by mass. The radiation-curable ink as mentioned herein is an ink that contains a polymerizable monomer and cures upon exposure to an ionization radiation (e.g., α-ray, electron, β-ray, positron, proton, deuteron, triton, heavy ion, charged neutron, X-ray, γ-ray, neutron, neutrino, and neutral neutron radiations) that ionizes and excites the monomer. When configured as a radiation-curable ink that contains 30% or more polymerizable monomer by mass, the white ink composition according to this embodiment may provide white images that lack whiteness and masking properties because in the resulting images the white-based-pigment particles are entirely surrounded by high-refractive-index polymer molecules derived from the polymerizable monomer.

### 3. INK SET

### 3.1. First Ink Set

A first ink set according to an embodiment of the invention includes the white-based ink composition described above and a clear ink. The clear ink is substantially free of coloring materials.

### 3.1.1. White-Based Ink Composition

The white-based ink composition in the first ink set preferably contains a binder resin as mentioned above. When the white-based ink composition is used in combination with a clear ink composition as in this ink set, it is more preferred that the refractive index of such a binder resin is less than 1.6, preferably 1.5 or less, and more preferably 1.4 or less. Binder resins that have a refractive index of 1.6 or more tend to affect the whiteness of the resulting images because such a binder resin with a refractive index of 1.6 or more reduces the difference in refractive index from the outside by spreading around the white-based-pigment particles.

Examples of binder resins that have a refractive index of less than 1.6 include fluorocarbon polymers, acrylic resins, and styrene resins. Such a resin can be used in a liquid form or in the form of particles dispersed in a liquid medium. It is also possible to use two or more such resins in combination.

Examples of fluorocarbon polymers that can be used include polytetrafluoroethylene, perfluoroalkoxy alkanes, perfluoroethylene-propene copolymers, ethylene-tetrafluoroethylene copolymers, polyvinylidene fluoride, polychlorotrifluoroethylene, ethylene-chlorotrifluoroethylene copolymers, tetrafluoroethylene-perfluorodioxole copolymers, and polyvinyl fluoride. Commercially available fluorocarbon polymers can also be used, including polytetrafluoroethylene (POLYFLON D-210C, a trade name, Daikin Industries, Ltd.).

Examples of acrylic resins that can be used include poly(meth)acrylic acid, (meth)acrylic acid-acrylonitrile copolymers, (meth)acrylic acid-methacrylonitrile copolymers, vinyl acetate-(meth)acrylate copolymers, (meth)acrylic acid-(meth)acrylate copolymers, styrene-(meth)acrylic acid copolymers, styrene-methacrylic acid-acrylate copolymers, styrene-α-methyl styrene-(meth)acrylic acid copolymers, and styrene-α-methyl styrene-(meth)acrylic acid-(meth)acrylate copolymers. The (meth)acrylic acid includes both acrylic and methacrylic acids, and the (meth)acrylate includes both an acrylate and the corresponding methacrylate. Commercially available acrylic resins can also be used, including UC-3000 and UC-3510 (trade names, Toagosei Co., Ltd.).

Examples of styrene resins that can be used include polystyrene, styrene-maleic acid copolymers, and styrene-maleic anhydride copolymers. Commercially available styrene resins can also be used, including styrene maleic resin (ARASTAR 700, a trade name, Arakawa Chemical Industries, Ltd.).

The refractive index of a binder resin as mentioned herein is the refractive index of a 1-μm-thick coating of the binder resin. Such a coating of binder resin can be prepared by the following method. One (1) part by mass of the binder resin is added to 100 parts by mass of an organic solvent (e.g., ethanol or toluene), and the resulting mixture is stirred to form a resin dispersion. A sheet of glass is then coated with the resin dispersion and stored in a vacuum desiccator at 25° C. for 24 hours so that the organic solvent will evaporate. A coating (a thickness of 1 μm) of the binder resin is obtained in such a way.

The refractive index of such a coating is measured using a refractometer, or more specifically using DR-A1 Abbe refractometer (a trade name, Atago Co., Ltd.) at 25° C. under the standard conditions. A spectroscopic ellipsometer can be used instead of DR-A1 Abbe refractometer if the coating has a high refractive index (e.g., 1.7 or more when measured using DR-A1 Abbe refractometer). Typical conditions of measurement with a spectroscopic ellipsometer are a temperature of 25° C. and a wavelength of 589.3 nm.

The amount (on a solid basis) of such a binder resin with a refractive index of less than 1.6 in the white-based ink composition in the first ink set is preferably in the range of 3% to 10% by mass, both inclusive, more preferably 3% to 8% by mass, both inclusive, based on the total mass of the white-based ink composition so that the fixation and abrasion resistance of the resulting white images can be sufficiently enhanced. The use of an appropriate amount of such a binder resin also prevents the white-based ink composition from clogging up the nozzle when used with an ink jet recording apparatus.

Other details of the white-based ink composition are as described above.

### 3.1.2. Clear Ink Composition

The clear ink composition in the first ink set is substantially free of coloring materials. The clear ink composition is therefore a colorless liquid that is transparent or translucent. The term substantially free of coloring materials as used herein refers to a state where the coloring material content of the ink is, for example, less than 0.5% by mass, more preferably less than 0.1% by mass, even more preferably less than 0.01% by mass, and the most preferably less than 0.005% by mass.

The clear ink composition in the first ink set is used to form a transparent layer on a white image recorded using the white-based ink composition to make the white image more resistant to abrasion, and is also used to form a transparent layer on a recording medium so that the white image recorded on the recording medium using the white-based ink composition can be more firmly fixed.

Thus, the clear ink composition in the first ink set preferably contains a binder resin for better abrasion resistance and fixation. As with the white-based ink composition, it is more preferred that the refractive index of such a binder resin is less than 1.6, preferably 1.5 or less, and more preferably 1.4 or less. Binder resins that have a refractive index of 1.6 or more tend to affect the whiteness of the resulting images because such a binder resin with a refractive index of 1.6 or more reduces the difference in refractive index from the outside by spreading around the white-based-pigment particles.

Examples of binder resins that have a refractive index of less than 1.6 are as listed above. It is also possible to use two or more such resins in combination.

The amount (on a solid basis) of such a binder resin with a refractive index of less than 1.6 in the clear ink composition in the first ink set is preferably in the range of 3% to 10% by mass, both inclusive, more preferably 3% to 8% by mass, both inclusive, based on the total mass of the clear ink composition so that the fixation and abrasion resistance of the resulting white images can be sufficiently improved. The use of an appropriate amount of such a binder resin also prevents the clear ink composition from clogging up the nozzle when used with an ink jet recording apparatus.

The clear ink composition in the first ink set may contain other resins such as polyolefin waxes and ethylene-vinyl acetate resins. Such additional resins help to reduce cracking in the resulting white images.

The first ink set may be used to record images on recording media that are not always white (e.g., plastic or metallic materials). For example, the first ink set may be used to erase the base color of a recording medium with the white-based ink composition. Likewise, when a color image is recorded on a transparent or translucent recording medium, the first ink set may be used to form a base layer with the white-based ink composition with the aim of making the color image less transparent. Although the specific mechanism is unclear, such a color image on a base layer formed with the white-based ink composition can crack. Possible causes include rapid shrinkage of the image that occurs as the inks dry and aggregation of the constituents of the white-based ink composition and the color ink composition. The clear ink composition effectively prevents this type of cracking in the resulting images and also makes the images highly resistant to abrasion when containing a polyolefin wax or an ethylene-vinyl acetate resin.

Such a polyolefin wax can be of any kind. Examples include waxes made from olefins such as ethylene, propylene, and butylene or olefin derivatives including copolymers, or more specifically polyethylene waxes, polypropylene waxes, and polybutylene waxes. In particular, polyethylene waxes are highly effective in reducing cracking in the resulting images. It is also possible to use two or more polyolefin waxes in combination.

Examples of ethylene-vinyl acetate resins that can be used include ethylene-vinyl acetate copolymers and copolymers that contain any other monomer(s). Such additional monomer(s) can be of any kind, and various known monomers can be used.

Such an ethylene-vinyl acetate resin can be provided as an emulsion (particles of the resin dispersed in a solvent) or a solution (the resin dissolved in a solvent) and is preferably provided as an emulsion. Emulsions are divided into two groups according to the process of emulsification, i.e., forced emulsification and self-emulsification, and emulsions of both groups can be used.

The amount (on a solid basis) of such a polyolefin wax and/or an ethylene-vinyl acetate resin in the clear ink composition in the first ink set is preferably in the range of 3% to 10% by mass, both inclusive, more preferably 3% to 8% by mass, both inclusive, based on the total mass of the clear ink composition so that cracking in the resulting images can be effectively reduced. The use of an appropriate amount of a polyolefin wax and/or an ethylene-vinyl acetate resin also prevents the clear ink composition from clogging up the nozzle when used with an ink jet recording apparatus.

As with the white ink composition, the clear ink composition in the first ink set may contain other appropriate components such as an organic solvent and a surfactant and additives such as pH-adjusting agents, preservatives/antimolds, antirusts, and chelating agents.

The first ink set may include the color ink composition described below. The first ink set can therefore be an ink set that includes the white-based ink composition, the clear ink composition, and the color ink composition.

### 3.1.3. Ink Jet Recording Method

An ink jet recording method according to this embodiment includes using the first ink set. An ink jet recording method that includes the use of the first ink set provides white images that have excellent whiteness, masking properties, and physical strength of pigment particles owing to the white-based ink composition that contains the white-based pigment described above, and also provides enhanced abrasion resistance to the white images owing to the clear ink composition that effectively reduces cracking in the images.

The ink jet recording method according to this embodiment can be performed in three ways: (1) droplets of the white-based ink composition and droplets of the clear ink composition are discharged substantially in the same process so that the droplets of the white ink composition and the droplets of the clear ink composition adhere to a recording medium while coming into contact with each other; (2) droplets of the white-based ink composition are first discharged onto a recording medium to form a white image, and then droplets of the clear ink composition are discharged onto the white image to form a transparent layer; (3) droplets of the clear ink composition are first discharged onto a recording medium to form a transparent layer, and then droplets of the white-based ink composition are discharged onto the transparent layer to form a white image.

The term discharged substantially in the same process as used herein means that the droplets of both inks are discharged in a timely manner that allows the droplets of one ink to be mixed with those of the other ink. The resulting image therefore contains a mixture of the two inks. A case that illustrates this is a serial printer that applies the white-based ink composition and the clear ink composition to the same position during one scan.

When the first ink set is used with an ink jet recording apparatus, the viscosity of the white-based ink composition and the clear ink composition at 20° C. is preferably in the range of 2 mPa·s to 10 mPa·s, both inclusive, more preferably 3 mPa·s to 6 mPa·s, both inclusive. The two ink compositions are ejected in appropriate amounts from nozzles when having a viscosity in these ranges at 20° C., which makes the ink compositions more unlikely to travel in random directions or spatter, thereby making the first ink set more suitable for use with an ink jet recording apparatus. The viscosity of the inks can be measured by analysis in VM-100AL oscillating viscometer (Yamaichi Electronics Co., Ltd.) at a constant temperature of 20° C.

### 3.2. Second Ink Set

A second ink set according to an embodiment of the invention includes the white-based ink composition described above and a color ink composition. The details of the white-based ink composition are as described above.

### 3.2.1. Color Ink Composition

The color ink composition in the second ink set contains a coloring material (different from the white-based pigment described above). The coloring material can be, for example, a color pigment or a color dye. The coloring material content of the color ink composition in the second ink set is preferably in the range of 1% to 20% by mass, both inclusive, more preferably 1% to 15% by mass, both inclusive, based on the total mass of the color ink composition.

### Color Pigments

Examples of color pigments that can be used in the color ink composition in the second ink set include all kinds of color pigments such as inorganic pigments and organic pigments. When the color ink composition contains a color pigment, it is preferred that the particle diameter of the color pigment in the color ink composition is greater than the largest surface void diameter of the white-based pigment (i.e., the largest diameter of the void of the white-based-pigment particles on the surface thereof). If the particle diameter of the color pigment is smaller than the largest surface void diameter of the white-based pigment, the resulting color images may lack sufficient brightness because the color pigment can intrude into the white-based pigment via the void on the surface of the white-based pigment.

Examples of inorganic pigments that can be used include carbon blacks (C.I. Pigment Black 7) such as furnace black, lamp black, acetylene black, and channel black, iron oxide, and titanium oxide.

Examples of organic pigments that can be used include azo pigments such as insoluble azo pigments, condensed azo pigments, azo lake pigments, and chelate azo pigments, polycyclic pigments such as phthalocyanine pigments, perylene and perinone pigments, anthraquinone pigments, quinacridone pigments, dioxane pigments, thioindigo pigments, isoindolinone pigments, and quinophthalone pigments, dye chelate pigments (e.g., basic-dye chelate pigments and acid-dye chelate pigments), dye lake pigments (e.g., basic-dye lake pigments and acid-dye lake pigments), nitro pigments, nitroso pigments, aniline black, and daylight fluorescent pigments.

It is also possible to use two or more such color pigments in combination.

More specifically, examples of black inorganic pigments that can be used include the following carbon blacks: Mitsubishi Chemical products such as No. 2300, No. 900, MCF88, No. 33, No. 40, No. 45, No. 52, MA7, MA8, MA100, and No. 2200B; Columbian Chemical products such as Raven 5750, Raven 5250, Raven 5000, Raven 3500, Raven 1255, and Raven 700; Cabot products such as Regal 400R, Regal 330R, Regal 660R, Mogul L, Monarch 700, Monarch 800, Monarch 880, Monarch 900, Monarch 1000, Monarch 1100, Monarch 1300, and Monarch 1400; and Degussa products such as Color Black FW1, Color Black FW2, Color Black FW2V, Color Black FW18, Color Black FW200, Color Black 5150, Color Black 5160, Color Black S170, Printex 35, Printex U, Printex V, Printex 140U, Special Black 6, Special Black 5, Special Black 4A, and Special Black 4.

Examples of yellow organic pigments that can be used include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, 180, 185, and 213.

Examples of magenta organic pigments that can be used include the following: C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, 245, 254, and 264; and C.I. Pigment Violet 19, 23, 32, 33, 36, 38, 43, and 50.

Examples of cyan organic pigments that can be used include the following: C.I. Pigment Blue 1, 2, 3, 15, 15:1, 15:2, 15:3, 15:4, 15:6, 15:34, 16, 18, 22, 25, 60, 65, and 66; and C.I. Vat Blue 4 and 60.

For other colors, examples of organic pigments that can be used include the following: C.I. Pigment Green 7 and 10; C.I. Pigment Brown 3, 5, 25, and 26; and C.I. Pigment Orange 2, 5, 7, 13, 14, 15, 16, 24, 34, 36, 38, 40, 43, and 63.

### Color Dyes

Color dyes that can be used include dyes commonly used in ink jet recording, such as direct dyes, acid dyes, food dyes, basic dyes, reactive dyes, disperse dyes, vat dyes, soluble vat dyes, and reactive disperse dyes.

Examples of yellow dyes that can be used include the following: C.I. Acid Yellow 1, 3, 11, 17, 19, 23, 25, 29, 36, 38, 40, 42, 44, 49, 59, 61, 70, 72, 75, 76, 78, 79, 98, 99, 110, 111, 127, 131, 135, 142, 162, 164, and 165; C.I. Direct Yellow 1, 8, 11, 12, 24, 26, 27, 33, 39, 44, 50, 58, 85, 86, 87, 88, 89, 98, 110, 132, 142, and 144; C.I. Reactive Yellow 1, 2, 3, 4, 6, 7, 11, 12, 13, 14, 15, 16, 17, 18, 22, 23, 24, 25, 26, 27, 37, and 42; C.I. Food Yellow 3 and 4; C.I. Solvent Yellow 15, 19, 21, 30, and 109.

Examples of magenta dyes that can be used include the following: C.I. Acid Red 1, 6, 8, 9, 13, 14, 18, 26, 27, 32, 35, 37, 42, 51, 52, 57, 75, 77, 80, 82, 85, 87, 88, 89, 92, 94, 97, 106, 111, 114, 115, 117, 118, 119, 129, 130, 131, 133, 134, 138, 143, 145, 154, 155, 158, 168, 180, 183, 184, 186, 194, 198, 209, 211, 215, 219, 249, 252, 254, 262, 265, 274, 282, 289, 303, 317, 320, 321, and 322; C.I. Direct Red 1, 2, 4, 9, 11, 13, 17, 20, 23, 24, 28, 31, 33, 37, 39, 44, 46, 62, 63, 75, 79, 80, 81, 83, 84, 89, 95, 99, 113, 197, 201, 218, 220, 224, 225, 226, 227, 228, 229, 230, and 231; C.I. Reactive Red 1, 2, 3, 4, 5, 6, 7, 8, 11, 12, 13, 15, 16, 17, 19, 20, 21, 22, 23, 24, 28, 29, 31, 32, 33, 34, 35, 36, 37, 38, 39, 40, 41, 42, 43, 45, 46, 49, 50, 58, 59, 63, and 64; C.I. Solubilized Red 1; and C.I. Food Red 7, 9, and 14.

Examples of cyan dyes that can be used include the following: C.I. Acid Blue 1, 7, 9, 15, 22, 23, 25, 27, 29, 40, 41, 43, 45, 54, 59, 60, 62, 72, 74, 78, 80, 82, 83, 90, 92, 93, 100, 102, 103, 104, 112, 113, 117, 120, 126, 127, 129, 130, 131, 138, 140, 142, 143, 151, 154, 158, 161, 166, 167, 168, 170, 171, 182, 183, 184, 187, 192, 199, 203, 204, 205, 229, 234, 236, and 249; C.I. Direct Blue 1, 2, 6, 15, 22, 25, 41, 71, 76, 77, 78, 80, 86, 87, 90, 98, 106, 108, 120, 123, 158, 160, 163, 165, 168, 192, 193, 194, 195, 196, 199, 200, 201, 202, 203, 207, 225, 226, 236, 237, 246, 248, and 249; C.I. Reactive Blue 1, 2, 3, 4, 5, 7, 8, 9, 13, 14, 15, 17, 18, 19, 20, 21, 25, 26, 27, 28, 29, 31, 32, 33, 34, 37, 38, 39, 40, 41, 43, 44, and 46; C.I. Solubilized Vat Blue 1, 5, and 41; C.I. Vat Blue 4, 29, and 60; C.I. Food Blue 1 and 2; and C.I. Basic Blue 9, 25, 28, 29, and 44.

For other colors, examples of dyes that can be used include the following: C.I. Acid Green 7, 12, 25, 27, 35, 36, 40, 43, 44, 65, and 79; C.I. Direct Green 1, 6, 8, 26, 28, 30, 31, 37, 59, 63, and 64; C.I. Reactive Green 6 and 7; C.I. Acid Violet 15, 43, 66, 78, and 106; C.I. Direct Violet 2, 48, 63, and 90; C.I. Reactive Violet 1, 5, 9 and 10; and C.I. Direct Black 154.

### Resin

The color ink composition in the second ink set may contain a resin as appropriate. The functions of such a resin include, for example, to fix the color ink to a recording medium and to make the coloring material more dispersible in the color ink. The amount of such a resin is preferably in the range of 0.1% to 10% by mass, both inclusive, more preferably 0.5% to 5% by mass, both inclusive, based on the total mass of the color ink composition. In general, coloring materials that can be used in the color ink compositions have a smaller particle diameter than that of the white-based pigment in the white-based ink composition. The coloring material in the color ink composition is thus unlikely to aggregate, and poor discharge is infrequent even if the resin content of the color ink composition is greater than that of the white-based ink composition.

Examples of resins that can be added to the color ink composition include known resins such as acrylic resins, urethane resins, polyolefin resins, rosin-modified resins, terpene resins, polyester resins, polyamide resins, epoxy resins, vinyl chloride resins, and vinyl chloride-vinyl acetate copolymers.

### Additives

As with the white ink composition, the color ink composition in the second ink set may contain other appropriate components such as an organic solvent and a surfactant and additives such as pH-adjusting agents, preservatives/antimolds, antirusts, and chelating agents.

### 3.2.2. Ink Jet Recording Method

An ink jet recording method according to this embodiment include using the second ink set with a recording head. The recording head operates on a greater potential difference to discharge the white-based ink composition than to discharge the color ink composition.

The following describes how the recording head is driven. The recording head can be used to discharge the white-based ink composition and/or the color ink composition in the second ink set through a nozzle(s). The changes in the relative position of the recording head to the recording medium and the timing of discharge are controlled so that the intended image will be recorded. The discharge-related parameters of the recording head other than timing, such as the amount of each ink discharged and the velocity of droplets, can also be changed by inputting different drive signals.

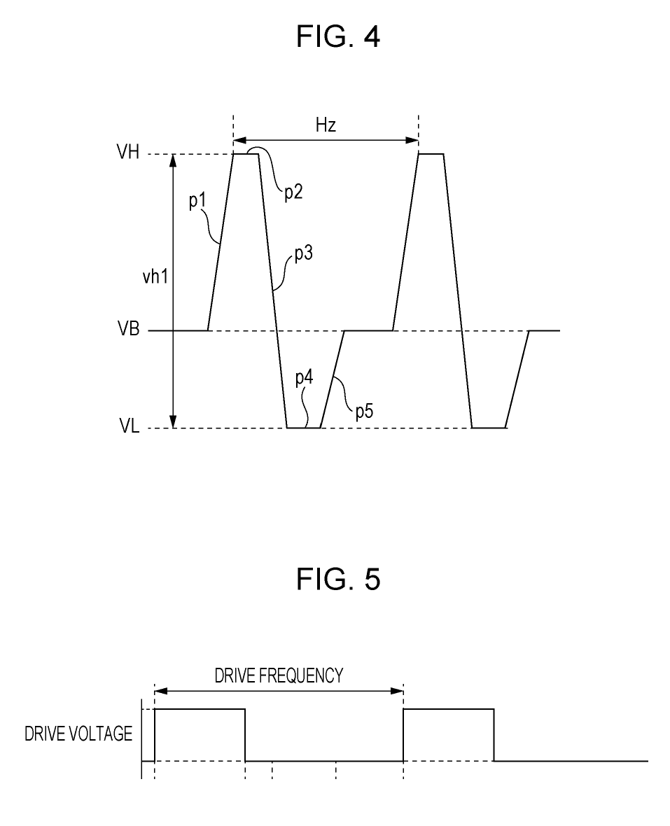

Taking a printer that incorporates piezoelectric elements as an example, a drive signal used to actuate the recording head can be described as follows. FIG. 4 illustrates a drive pulse in a drive signal. In FIG. 4, the vertical axis represents the potential of the drive pulse, and the horizontal axis represents time. The difference between the lowest potential VL and the highest potential VH of the drive pulse (i.e., the drive voltage) is defined as vhf. The drive pulse includes five components: an expansion component p1, which expands pressure chambers and in which the potential changes in the positive direction from the baseline potential VB to the expansion potential VH; an expansion-holding component p2, in which the potential stays at the expansion potential VH for a certain period of time; a contraction component p3, which makes the pressure chambers rapidly contract and in which the potential changes in the negative direction from the expansion potential VH to the contraction voltage VL; a contraction-holding (vibration-compensating) component p4, in which the potential stays at the contraction potential VL for a certain period of time; and a recovery component p5, in which the potential returns from the contraction potential VL to the baseline potential VB.

The following describes how the drive pulse acts on the elements of the printer responsible for discharge (e.g., heaters and piezoelectric elements; hereinafter piezoelectric elements taken as an example). First, the piezoelectric elements given the expansion component p1 contract, and the contiguous pressure chambers are accordingly deformed, changing the capacity from the baseline capacity that corresponds to the baseline potential VB to the maximum capacity that corresponds to the highest potential VH (i.e., the pressure chambers expand). As a result, the meniscus of the ink composition exposed in the nozzle is drawn to the pressure chamber side. The pressure chambers remain expanded while the expansion-holding component p2 is provided.

After the expansion-holding component p2, the piezoelectric elements expand upon receiving the contraction component p3, which is a change in voltage in the direction opposite the voltage change provided by the expansion component p1, and the pressure chambers are rapidly deformed, changing the capacity from the maximum capacity to the minimum capacity that corresponds to the lowest potential VL (i.e., the pressure chambers contract). This rapid contraction of the pressure chambers pressurizes the ink composition in the pressure chambers, resulting in several to dozens of picoliters of the ink composition being ejected from the nozzle. The pressure chambers remain contracted for a short period of time while the contraction-holding component p4 is provided. Then the recovery component p5 is supplied to the piezoelectric elements, and the capacity of the pressure chambers returns from the capacity that corresponds to the lowest potential VL to the baseline capacity that corresponds to the baseline potential VB. The amount of the ink composition ejected from the nozzle (the droplet size) can also be increased by raising the slope of the expansion component p1 and the contraction component p3 (i.e., the absolute change in voltage per unit time).

Such a drive pulse is selectively output to the piezoelectric elements of the recording head from a drive signal, and the corresponding nozzle ejects the ink composition to the substrate (medium). The ejection of the ink composition from the recording head can therefore be controlled by controlling this drive signal.

Drive signals have some common control variables such as the frequency of the discharge of droplets (the discharge frequency, which corresponds to the interval between one head-driving event to the next and typically is the inverse of the length of time from the discharge of one droplet to that of the next one; Hz in FIG. 4) and the drive voltage for discharge (the waveform amplitude (potential difference) during discharge). The potential difference (drive voltage) of any waveform that has no expansion component p1 for expanding the pressure chambers is provided by the difference between the baseline potential VB and the contraction potential VL. Controlling the drive voltage and the voltage waveform also provides a way to control the flight speed of discharged droplets. Adjusting the discharge parameters by controlling the drive signal is possible both in piezoelectric ink jet printers and in thermal ink jet printers. The recording head used in this embodiment can therefore be used regardless of the mode of actuation. Various modifications are possible to the waveform; the recording head may be driven by a waveform like that in FIG. 5 when used in a piezoelectric or thermal ink jet printer.

The ink jet recording method according to this embodiment includes the use of the second ink set described above with an ink jet recording apparatus, and the driving signal can be selected as appropriate. Preferably, the recording head operates on a greater potential difference to discharge the white-based ink composition than to discharge the color ink composition. A higher drive potential difference for the discharge of the white-based ink composition in the waveform provides similar droplet sizes to the two ink compositions because the white-based pigment disclosed herein is more difficult to discharge than the coloring material contained in the color ink composition. Likewise, it is preferred to use a steeper waveform to discharge the white-based ink composition, which contains the white-based pigment disclosed herein, than to discharge the color ink composition because this also provides similar droplet sizes to the two ink compositions. More preferably, the difference between the flight speed (m/s) of the first droplet of the white-based ink composition to record a white image and the flight speed (m/s) of the first droplet of the color ink composition to record a color image is less than 4 (m/s), in particular, less than 2 (m/s).

This provides good discharge stability to both the white-based ink composition and the color ink composition, which is particularly effective in preventing missing dots in the white image formed by the white-based ink composition, thereby providing excellent whiteness to the white image.

When the second ink set is used with an ink jet recording apparatus, the viscosity of the white-based ink composition and the color ink composition at 20° C. is preferably in the range of 2 mPa·s to 10 mPa·s, both inclusive, more preferably 3 mPa·s to 6 mPa·s, both inclusive. The two ink compositions are ejected in appropriate amounts from nozzles when having a viscosity in these ranges at 20° C., which makes the ink compositions more unlikely to travel in random directions or spatter, thereby making the second ink set more suitable for use with an ink jet recording apparatus. The viscosity of the inks can be measured by analysis in VM-100AL oscillating viscometer (Yamaichi Electronics Co., Ltd.) at a constant temperature of 20° C.

### 4. EXAMPLES

The following illustrates some examples and comparative examples of the invention to describe some aspects of the invention in more detail. These examples should not be construed as limiting the scope of the invention. The units of measurement “parts” and “%” in the following examples and comparative examples are all on a mass basis unless otherwise specified.

### 4.1. Preparation of White-Based Pigments

4.1.1. White-based-pigment particles A to C

Cetyl trimethyl ammonium bromide (hereinafter also referred to as CTAB) and 1-hexadecanol were sequentially dissolved in 25 g of water. The molar ratio of CTAB to 1-hexadecanol was 1:1 (CTAB:1-hexadecanol). The obtained mixture was heated to 60° C. and stirred for about 24 hours. Then 3 M titanium oxide sulfate aqueous solution was added, and the obtained mixture was stirred for 24 hours at 60° C. The molar ratio of CTAB to titanium oxide sulfate was 1:50 (CTAB:titanium oxide sulfate). The reaction product collected by suction filtration was washed with water, and the washed product was dried at 120° C. for 10 hours. In this way, mesoporous titanium oxide particles A were obtained.

The radius r and the particle diameter K3 of the obtained white-based-pigment particles A were measured using a laser diffraction particle size distribution analyzer (Microtrac UPA, Nikkiso Co., Ltd.), and the measured radius r was used to determine the T1 (=4πr²) of the white-based-pigment particles A. The specific surface area T2 of the white-based-pigment particles A was determined by gas adsorption using FlowSorb III 2305/2310 automated dynamic-flow surface area analyzer (Shimadzu Corporation). From the determined T1 and T2, the structural factor K1 was calculated by equation (2).

K1=log₁₀(T2/T1) (2)

The capacity of pores of the white-based-pigment particles A was determined by mercury intrusion using AutoPore IV 9520 pore size distribution analyzer (Shimadzu Corporation) from the pressure used to force mercury into the pores and the amount of mercury that intruded, and this capacity of pores and the initial volume (bulk volume) were used to calculate the porosity K2.

The specific gravity K4 of titanium dioxide is 4.29. These values were substituted into equation (1) to give the value of S. Table 1 lists the values of K1, K2, K3, K4, and S.

$$S = \frac{K 1 \times ( 1 - K 2 ) \times {a ( K 3 )}^{2}}{K 4} \qquad ( 1 )$$

The white-based-pigment particles B and C in Table 1 are mesoporous white-based-pigment particles that were obtained with different ratios of CTAB to 1-hexadecanol. The white-based-pigment particles D in Table 1 are commercially available NanoTek® Slurry (C.I. Kasei Co., Ltd.). NanoTek® Slurry contains 15% solid titanium dioxide particles with an average particle diameter of 300 nm. The parameters of the white-based-pigment particles B to D were determined in the same way as those of the white-based-pigment particles A. The results are summarized in Table 1.

### 4.1.2. White-Based-Pigment Particles E and F

The following materials were put into a 2-L flask: 80 parts by mass of styrene, 5 parts by mass of methacrylic acid, 15 parts by mass of methyl methacrylate, 4 parts by mass of α-methyl styrene dimer, 14 parts by mass of t-dodecylmercaptan, 0.8 parts by mass of sodium dodecyl benzene sulfonate, 1.0 part by mass of potassium persulfate, and 200 parts by mass of water. Emulsification polymerization was allowed to proceed for 6 hours in a nitrogen gas at 80° C. while the flask was stirred, producing seed polymer particles with a polymerization yield of 98%. The average particle diameter and the weight-average molecular weight (Mw) of the obtained seed particles were 0.15 μm and 3,500, respectively.

Then 10 parts by mass (on a solid basis) of these seed particles, 0.3 parts by mass of sodium lauryl sulfate, 0.5 parts by mass of potassium persulfate, and 400 parts by mass of water were put into a reaction vessel. A cross-linking polymerizable monomer composition, or more specifically a mixture of 11.6 parts by mass of divinyl benzene (purity: 55% by mass divinyl benzene and the monofunctional vinyl monomer as the balance), 8.4 parts by mass of ethyl vinyl benzene, 5 parts by mass of acrylic acid, and 75 parts by mass of methyl methacrylate, was then added to the reaction vessel. The reaction vessel was stirred at 30° C. for 1 hour so that almost all of the monomer content of the cross-linking polymerizable monomer composition could be absorbed into the seed particles. Then emulsification polymerization was allowed to proceed for 5 hours at 70° C. while the reaction vessel was stirred, producing an aqueous dispersion of polymeric particles composed of capsules and water therein (white-based-pigment particles E) with a polymerization yield of 99%. The parameters of the obtained white-based-pigment particles E were determined in the same way as those of the white-based-pigment particles A. The results are summarized in Table 1.

The white-based-pigment particles F in Table 1 are also polymeric particles composed of capsules and water therein and were obtained with different proportions of the polymerizable monomers, the polymerization initiator, and the emulsifier. The parameters of the white-based-pigment particles F were also determined in the same way as those of the white-based-pigment particles A. The results are summarized in Table 1.

### 4.2. Preparation of White-Based Ink Compositions

Ten (10) parts by mass of one white-based pigment in Table 1, 2 parts by mass of a styrene-acrylic resin, 1 part by mass of BYK-348 (a trade name, BYK Japan KK, a silicone surfactant), 10 parts by mass of trimethylol propane (Kanto Chemical Co., Inc.), 3 parts by mass of 1,2-hexanediol (Mitsubishi Gas Chemical Co., Inc.), and 2 parts by mass of 2-pyrrolidone (Kanto Chemical Co., Inc.) were put into a vessel with ion-exchanged water that made the total mass 100 parts. The materials were blended by stirring the vessel for 2 hours using a magnetic stirrer. The mixture was then filtered through a 5-μm metal filter, and the residue was degassed using a vacuum pump. In this way, white-based ink compositions of Examples and Comparative Examples were obtained.

### 4.3. Testing

### 4.3.1. Whiteness

Each of the obtained white-based ink compositions was used to record a solid image. The ink tank of a dedicated cartridge for an ink jet printer (PX-G930, a trade name, Seiko Epson Corp.) was filled with the ink composition, and the printer was loaded with the ink cartridge. Using this printer, the solid image was recorded on a recording medium (Epson Clear Proof Film, a trade name, Seiko Epson Corp., precut to the A4 size) under the following conditions: weight per dot, 11 ng; resolution, 1440×1440 dpi; duty, 100%.

The value L* (whiteness) of the recorded images was measured using Spectrolino spectrophotometer (a trade name, GretagMacbeth) under the following conditions: light source, D50; field of view, 2°. The criteria for assessment were as presented below, and the results are summarized in Table 1.

During this spectrophotometric measurement the samples were covered with black paper on the side opposite the side of measurement. The OD of the black paper was 2.0 when measured using the same spectrophotometer.

A: L*≧75

B: 70≦L*<75

C: L*<70

4.3.2. Masking properties

The masking properties were evaluated on samples obtained in the same way as in 4.3.1. Whiteness. More specifically, the transmittance Tn (%) of light through each sample was measured using ARM-500V multi-angle colorimeter (a trade name, JASCO Corporation) in the visible range (380 nm to 800 nm) with 1-nm increments, and the shielding efficiency S was determined by integrating the wavelength-specific transmittance measurements. The shielding efficiency S is a numeric value in the range of 0 to 32000, with the value 0 indicating complete masking (shielding) and 32000 complete transmission. The criteria for assessment were as follows, and the results are summarized in Table 1.

A: Shielding efficiency S<500

B: 500≦Shielding efficiency S<1000

C: Shielding efficiency S≧1000

### 4.3.3. Physical Strength of Pigment Particles

The physical strength of pigment particles was evaluated by a finger and nail scratch test (a test in which a person rubs and scratches the surface of the recording with a finger and a nail two to three times) on samples obtained in the same way as in 4.3.1. Whiteness. The criteria for assessment were as follows, and the results are summarized in Table 1.

A: The image remained intact even when rubbed and scratched hard with a finger and a nail.

B: The image remained intact when rubbed with a finger but was damaged when scratched with a nail.

C: The image was damaged when rubbed with a finger.

### 4.3.4. Potential to Settle Out (Storage Stability)

Each of the obtained white-based ink compositions was diluted with ion-exchanged water to form a dispersion that contained 10% by mass white-based ink composition (viscosity: 10). Ten (10) milliliters of the dispersion in a 10-mL measuring cylinder was left at room temperature (25° C.) and 50% RH for 1 week. Then 2 mL of the supernatant of the dispersion in the measuring cylinder was collected.

One (1) gram of the obtained sample was diluted with distilled water by a factor of 1000. The absorbance (Abs) of the dilution was measured at a wavelength of 500 nm using a spectrophotometer (U-3300 Spectrophotometer, a trade name, Hitachi, Ltd.). The percent residual absorbance of each sample was calculated from the absorbance of a 1000-fold dilution in distilled water immediately after preparation and that of the 1000-fold dilution of the sample stored for 1 week by equation (3).

Percent residual absorbance (%)=100×(Absorbance after 1-week storage/Absorbance immediately after preparation) (3)

The potential of the white-based ink compositions to settle out (storage stability) was assessed by the criteria presented below. A higher percent residual absorbance means better storage stability. The results are summarized in Table 1.

A: Percent residual absorbance 90%

B: 70% Percent residual absorbance <90%

C: Percent residual absorbance <70%

### 4.4. Test Results

Table 1 summarizes the scores of Examples 1 to 3 and Comparative Examples 1 to 3 for whiteness, masking properties, physical strength of pigment particles, and the potential to settle out.

TABLE 1

| | | | | | Comparative | Comparative | Comparative |
|---|---|---|---|---|---|---|---|
| | | Example 1 | Example 2 | Example 3 | Example 1 | Example 2 | Example 3 |
| White- | Type | A | B | C | D | E | F |
| based | K1 | 2.50 | 1.80 | 0.80 | 0.70 | 0.15 | 0.54 |
| pigment | K2 | 0.30 | 0.50 | 0.77 | 0.05 | 0.40 | 0.10 |
| | K3 | 3.0 × 10⁻⁷ | 6.0 × 10⁻⁷ | 6.0 × 10⁻⁷ | 3.0 × 10⁻⁷ | 3.5 × 10⁻⁷ | 1.4 × 10⁻⁷ |
| | K4 | 4.29 | 4.29 | 4.29 | 4.29 | 1.10 | 1.20 |
| | S | 0.37 | 0.76 | 0.15 | 0.14 | 0.10 | 0.08 |
| Test | Whiteness | A | A | A | A | A | C |
| results | Masking | A | B | B | A | B | C |
| | properties | | | | | | |
| | Potential to | A | A | A | C | B | A |
| | settle out | | | | | | |
| | Physical | A | A | A | A | C | B |
| | strength of | | | | | | |
| | pigment | | | | | | |
| | particles | | | | | | |

As shown in Table 1, the white-based ink compositions that had an S of 0.15 or more achieved good results for all of whiteness, masking properties, physical strength of pigment particles, and the potential to settle out. It can also be seen from Table 1 that the white-based ink compositions that had an S of less than 0.15 were found to be inferior in at least one of whiteness, masking properties, physical strength of pigment particles, and the potential to settle out. Table 1 therefore provides ample evidence for the technical significance of the numeric value S defined by equation (1).

The invention is not limited to the embodiments described above and can be modified in various ways. For example, the invention includes constitutions that are substantially the same as the preceding embodiments (e.g., those that have the same function, are used or made by the same method, and provide the same results or are for the same purposes and advantages). The invention also includes constitutions obtained by changing any nonessential part of the preceding embodiments. Furthermore, the invention includes constitutions that have the same operations and offer the same advantages as the preceding embodiments and constitutions that can achieve the same objects as the preceding embodiments. The invention also includes constitutions obtained by adding any known technology to the preceding embodiments.

What is claimed is:

1. A white-based pigment having an S of at least 0.15, the S defined by equation (1):
$$S = \frac{K 1 \times ( 1 - K 2 ) \times {a ( K 3 )}^{2}}{K 4} \qquad ( 1 )$$
where K1, K2, K3, and K4 are a structural factor, a porosity, a particle diameter, and a specific gravity, respectively, and 0<K1, 0<K2<1, 1.5×10⁻⁷ (m)≦K3≦1.0×10⁻⁵ (m), 2≦K4≦8, and a=1.0×10¹³ (m⁻²).

2. A white-based ink composition comprising
the white-based pigment according to claim 1.

3. The white-based ink composition according to claim 2, wherein the white-based ink composition is a textile printing ink.

4. An ink set comprising:
the white-based ink composition according to claim 2; and
a clear ink composition substantially free of coloring materials.

5. The ink set according to claim 4, wherein the white-based ink composition contains a binder resin that has a refractive index of less than 1.6.

6. An ink set comprising:
the white-based ink composition according to claim 2; and
a color ink composition containing a coloring material,
the coloring material in the color ink composition having a particle diameter longer than a largest surface void diameter of the white-based pigment in the white-based ink composition.

7. An ink jet recording method comprising
using the ink set according to claim 4.

8. An ink jet recording method comprising
using the ink set according to claim 5.

9. An ink jet recording method comprising
using the ink set according to claim 6.

10. An ink jet recording method comprising
using the ink set according to claim 6 with a recording head,
the recording head configured to operate on a greater potential difference to discharge the white-based ink composition than to discharge the color ink composition.
